(19) United States
(12) Patent Application Publication
(10) Pub. No.: US 2012/0008934 A1
(43) Pub. Date: Jan. 12, 2012

(54) CAMERA MODULE AND METHOD OF MANUFACTURING THE SAME

(76) Inventor: Atsuko KAWASAKI, Yokohama-shi (JP)

(21) Appl. No.: 13/176,918

(22) Filed: Jul. 6, 2011

(30) Foreign Application Priority Data
Jul. 6, 2010 (JP) 2010-154273

(51) Int. Cl. G03B 17/00; C23F 1/00; B32B 37/14; B32B 38/10; B32B 37/02; B32B 37/12

(52) U.S. Cl. 396/529; 156/60; 156/249; 156/247; 156/150; 216/13

(57) ABSTRACT

According to one embodiment, a camera module is disclosed. The module includes a semiconductor substrate having a first main surface and a second main surface facing the first main surface. An imaging region is provided on the first main surface. A penetrative electrode penetrates through the semiconductor substrate between the first main surface and the second main surface. An adhesive layer is provided on the first main surface, the adhesive layer being located outside the imaging region. And a lens member is directly bonded to the adhesive layer, the lens member seals the imaging region and houses an imaging lens therein.

### CROSS-REFERENCE TO RELATED APPLICATIONS

This application is based upon and claims the benefit of priority from Japanese Patent Application No. 2010-154273, filed Jul. 6, 2010; the entire contents of which are incorporated herein by reference.

### FIELD

Embodiments described herein relate generally to a camera module and a method of manufacturing the same.

### BACKGROUND

As electronic devices are getting smaller and thinner, camera modules installed in the electronic devices have to be made smaller and thinner. A camera module includes a solid-state imaging device. Making a solid-state imaging device thinner is referred to as low height.

WLCSP (Wafer Level Chip Scale Package) is adopted for the low height of the solid-state imaging device. Some of WLCSPs are of a type that uses an electrode structure called TCV (Through Chip Via) or TSV (Through Si Via). In this type of WLCSP, an integrated circuit including a light-receiving element provided on the surface of a semiconductor substrate is electrically connected to an external connecting terminal provided on a rear surface of the semiconductor substrate by a penetrative electrode penetrating through the semiconductor substrate.

When the penetrative electrode is formed, the semiconductor substrate is supported on a transparent support substrate by an adhesive layer. The semiconductor substrate having the penetrative electrode formed therethrough and the transparent support substrate are incorporated in the camera module.

### BRIEF DESCRIPTION OF THE DRAWINGS

FIG. 1 is a sectional view showing a schematic configuration of a camera module according to a first embodiment;

FIG. 2 is a sectional view showing a more detailed configuration of an imaging lens and a lens holder in the camera module of the first embodiment;

FIG. 3 is a sectional view showing a schematic configuration of a camera module of a comparative example;

FIGS. 4A, 4B, and 4C are sectional views to explain a first manufacturing method of a first module section of the first embodiment;

FIGS. 5A, 5B, 5C, and 5D are sectional views to explain a second manufacturing method of the first module section of the embodiment;

FIGS. 6A, 6B, and 6C are sectional views to explain a third manufacturing method of the first module section of the first embodiment;

FIGS. 7A, 7B, 7C, and 7D are sectional views to explain in detail the third manufacturing method;

FIGS. 8A, 8B, 8C, 8D, and 8E are sectional views to explain in detail the third manufacturing method following FIG. 7D;

FIG. 9 is a sectional view showing a schematic configuration of a camera module according to a second embodiment;

FIG. 10 is a sectional view showing a schematic configuration of a camera module according to a third embodiment;

FIG. 11 is a sectional view showing a schematic configuration of a camera module according to a fourth embodiment;

FIG. 12 is a sectional view showing a modification of the camera module according to the fourth embodiment;

FIG. 13 is a sectional view showing another modification of the camera module according to the fourth embodiment;

FIG. 14 is a sectional view to explain a manufacturing method of a camera module according to a fifth embodiment;

FIG. 15 is a sectional view to explain a manufacturing method of the camera module according to the fifth embodiment following FIG. 14;

FIG. 16 is a sectional view to explain a manufacturing method of the camera module according to the fifth embodiment following FIG. 15;

FIG. 17 is a sectional view to explain a manufacturing method of a camera module according to a sixth embodiment;

FIG. 18 is a sectional view to explain a manufacturing method of the camera module according to the sixth embodiment following FIG. 17;

FIG. 19 is a sectional view to explain a manufacturing method of the camera module according to the sixth embodiment following FIG. 18;

FIG. 20 is a sectional view to explain a manufacturing method of a camera module according to a seventh embodiment;

FIG. 21 is a sectional view to explain a manufacturing method of the camera module according to the seventh embodiment following FIG. 20;

FIG. 22 is a sectional view to explain a manufacturing method of the camera module according to the seventh embodiment following FIG. 21;

FIG. 23 is a sectional view to explain a manufacturing method of the camera module according to the seventh embodiment following FIG. 22;

FIG. 24 is a sectional view to explain a manufacturing method of a camera module according to an eighth embodiment; and

FIG. 25 is a sectional view to explain a manufacturing method of the camera module according to the eighth embodiment following FIG. 24.

### DETAILED DESCRIPTION

Hereinafter, referring to the accompanying drawings, embodiments will be explained.

In general, according to an embodiment, there is provided a camera module. The camera module includes a semiconductor substrate having a first main surface and a second main surface facing the first main surface. The module includes an imaging region provided on the first main surface. The module includes a penetrative electrode penetrating through the semiconductor substrate between the first main surface and the second main surface. The module includes an adhesive layer provided on the first main surface, the adhesive layer being located outside the imaging region. And the module includes a lens member directly bonded to the adhesive layer, the lens member sealing the imaging region and the lens member housing an imaging lens therein.

According to an embodiment, there is provided a method of manufacturing a camera module. The camera module includes a semiconductor substrate having a first main surface and a second main surface facing the first main surface, the semiconductor substrate having a thickness of D1; an imaging region provided on the first main surface; a penetrative electrode penetrating through the semiconductor substrate between the first main surface and the second main surface; an adhesive layer provided on the first main surface, the adhesive layer being located outside the imaging region; and a lens member directly bonded to the adhesive layer, the lens member sealing the imaging region and the lens member housing an imaging lens therein. The method includes forming the imaging region on a first main surface of a semiconductor substrate having a thickness of D2 (>D1). The method includes thinning the semiconductor substrate to D1, the thinning being started from a second main surface side of the semiconductor substrate, the second main surface facing the first main surface. The method includes forming the penetrative electrode in a through hole, the through hole penetrating through the semiconductor substrate between the first main surface and the second main surface. The method includes providing the adhesive layer on the first main surface outside the imaging region. And the method includes directly bonding the lens member to the adhesive layer.

According to an embodiment, there is provided another method of manufacturing a camera module. The camera module includes a semiconductor substrate having a first main surface and a second main surface facing the first main surface, the semiconductor substrate having a thickness of D1; an imaging region provided on the first main surface; a penetrative electrode penetrating through the semiconductor substrate between the first main surface and the second main surface; an adhesive layer provided on the first main surface, the adhesive layer being located outside the imaging region; and a lens member directly bonded to the adhesive layer, the lens member sealing the imaging region and the lens member housing an imaging lens therein. The method includes forming the imaging region on a first main surface of a semiconductor substrate having a thickness of D2 (>D1). The method includes forming a trench in the first main surface. The method includes forming the penetrative electrode in the trench. The method includes thinning the semiconductor substrate to D1, the thinning being starting from a second main surface side of the semiconductor substrate, the second main surface facing the first main surface. The method includes providing the adhesive layer on the first main surface outside the imaging region. And the method includes directly bonding the lens member to the adhesive layer.

### First Embodiment

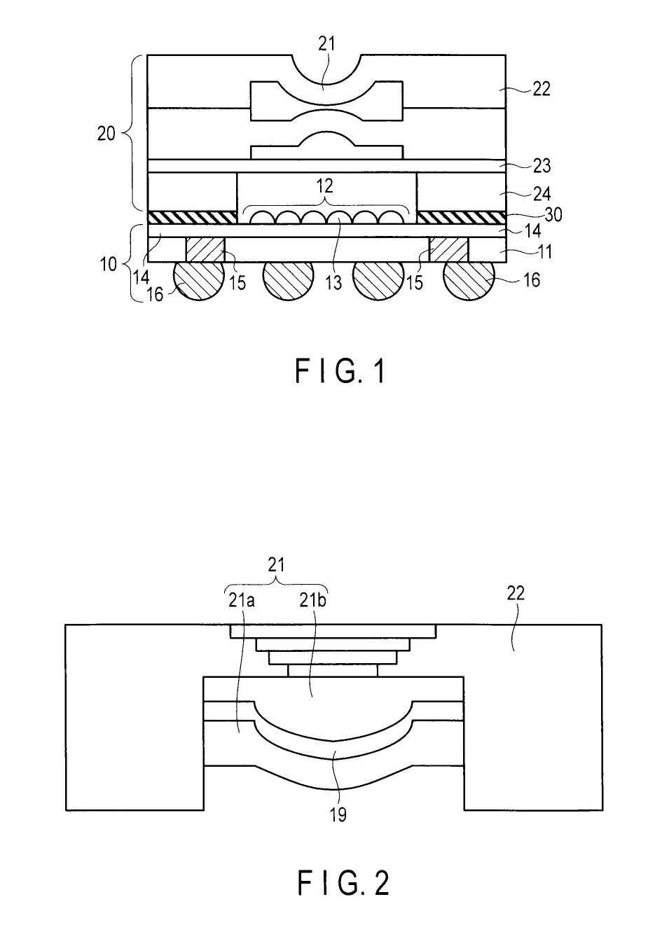

FIG. 1 is a sectional view showing a schematic configuration of a camera module according to a first embodiment.

The camera module of the present embodiment is a module for imaging an incident image (subject image) by imaging element in which the incident image enters through an imaging lens, and the camera module comprises a first module section 10 including the imaging element and a second module section (a lens member) 20 including the imaging lens.

The first module section 10 comprises a silicon substrate 11. An imaging region 12 configured to output a signal corresponding to the incident light is provided on the surface (a first main surface) of the silicon substrate 11.

The imaging region 12 comprises a microlens 13.

The imaging region 12 further comprises an imaging element (not shown). The imaging element is constituted of, for example, a CMOS sensor or a CCD sensor.

A circuit region 14 configured to transmit a signal output from the imaging region 12 is provided on the silicon substrate 11 around the imaging region 12.

Penetrative electrodes 15 that penetrate through the silicon substrate 11 is provided in the silicon substrate 11 between the surface (the first main surface) of the silicon substrate 11 and a rear surface (a second main surface) of the silicon substrate. On the rear surface of the silicon substrate 11, solder balls 16 as external terminals are provided. The circuit region 14 is connected to the solder balls 16 via the penetrative electrodes 15. A signal from the imaging element transmitted via the circuit region 14 is output via the penetrative electrodes 15 to the solder balls 16.

On the other hand, the second module section 20 comprises an imaging lens 21. The second module section 20 further comprises a lens holder (a lens holding member) 22 for holding the imaging lens 21.

FIG. 2 shows a more detailed configuration of the imaging lens 21 and lens holder 22. In FIG. 2, two imaging lenses 21a, 21b are shown, but the number of imaging lenses may be one, three, or more, depending on the performance or price of the camera module. In FIG. 2, numeral 19 indicates a cavity.

Referring back to FIG. 1, an IR cut filter (IRCF) 23 is provided below the lens holder 22 so as to face the imaging lens 21.

A spacer 24 is provided below the lens holder 22 outside the IRCF 23. The spacer 24 is shaped like a frame that encloses the imaging region 12. The thickness of the spacer 24 is set so that the distance between the imaging lens 21 and the imaging region 12 (imaging element) coincides with the focal length of the imaging lens 21.

The adhesive layer 30 is provided on the circuit region 14 of the first module section 10 excluding the imaging region 12. The adhesive layer 30 is made of a known adhesive material. The second module section 20 is directly bonded to the adhesive layer 30 so as to seal the imaging region 12 of the first module section 10.

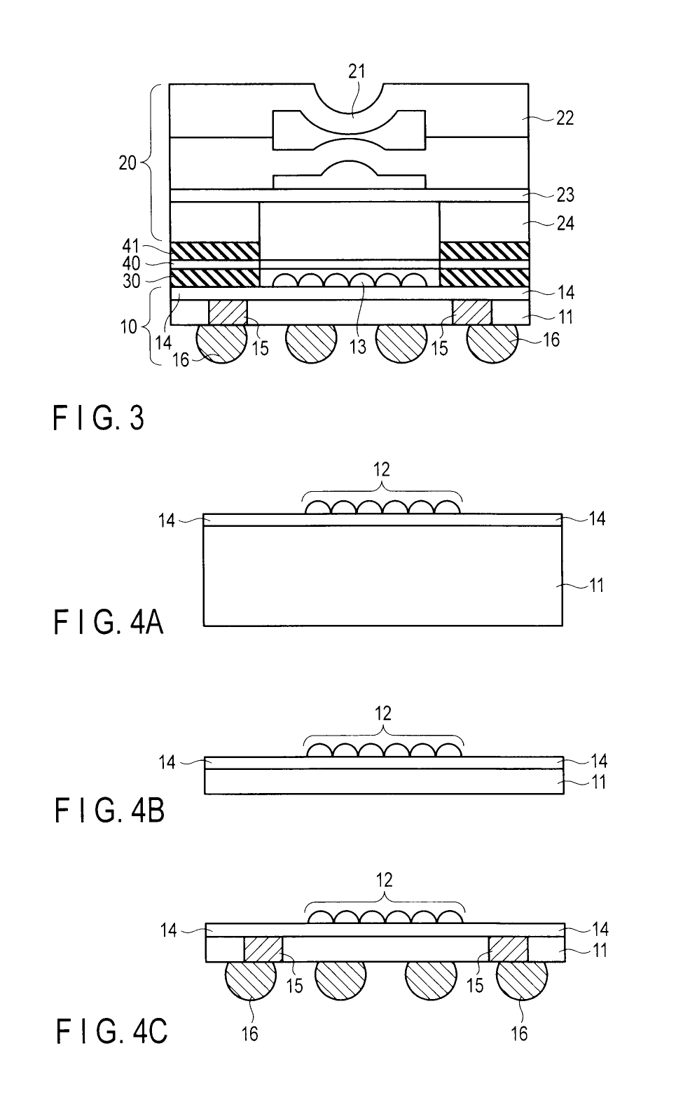

FIG. 3 is a sectional view showing a schematic configuration of a camera module of a comparative example.

The camera module of a comparative example comprises cover glass 40. The imaging region of the first module section 10 is sealed with the cover glass 40. Reference numeral 41 indicates an adhesive layer for bonding the cover glass 40 and lens member 20 together.

In the comparative example, the camera module is thicker than that of the present embodiment by the thickness of the cover glass 40. That is, according to the present embodiment, the cover glass 40 is not needed and therefore the low height may be realized easily. Moreover, in the present embodiment, the adhesive layer 41 needed in the comparative example is not necessary. This is advantageous for achieving the low height.

Furthermore, in the case of the comparative example, the light passed through the lens enters the imaging region via the cover glass 40. In this case, the focal length of the light becomes longer than when the cover glass 40 is not used. Therefore, the distance between the cover glass 40 and the imaging region must be made longer by an increase in the focal distance. This makes it difficult to achieve the low height.

FIG. 4 shows a method of manufacturing a first module section (a first manufacturing method).

In this manufacturing method, first, as shown in

FIG. 4A, an imaging element (not shown), a circuit region 14, and a microlens are formed on the surface of a silicon substrate 11 (D2 in thickness) by a known method.

Next, as shown in FIG. 4B, the silicon substrate 11 is thinned from the rear surface so that the silicon substrate 11 have a predetermined thickness (D1).

Then, as shown in FIG. 4C, penetrative electrodes 15 and solder balls 16 are formed.

Thereafter, an adhesive layer is formed on the circuit region 14 excluding the imaging region 12, and a second module is directly bonded to the adhesive layer, thereby producing the camera module. In this method, the adhesive layer 30 and second module section 30 are formed after the formation of the solder balls 16, whereas, by changing order, the solder balls 16 may be formed after the adhesive layer 30 and second module section 20 is formed.

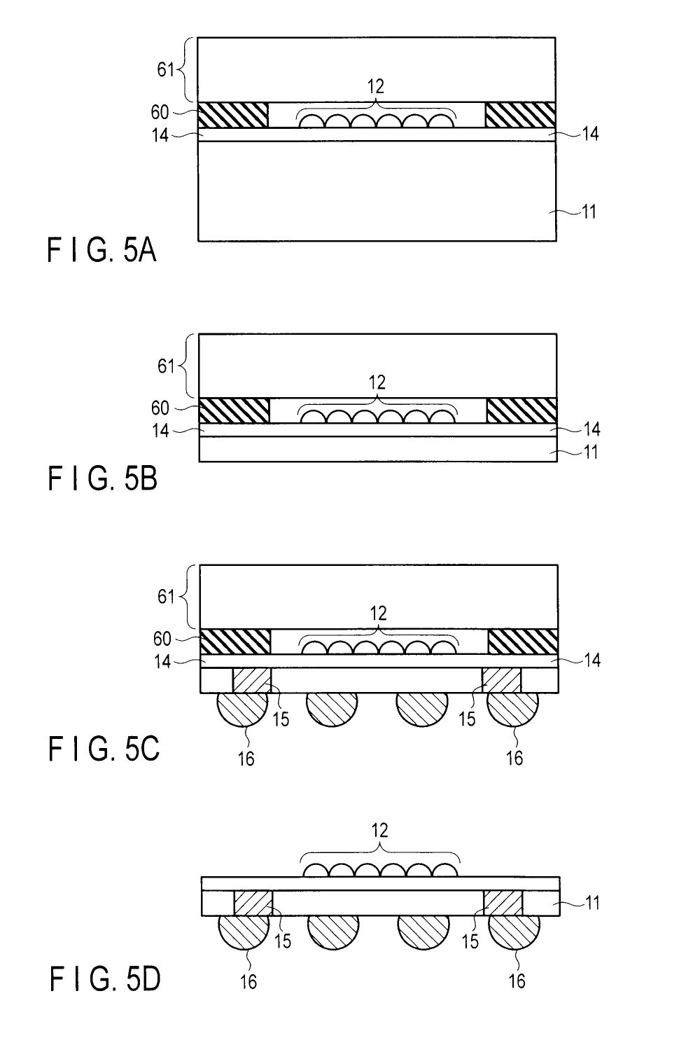

FIG. 5 shows another method of manufacturing a first module section (a second manufacturing method).

In this manufacturing method, after the step of FIG. 4A, the silicon substrate 11 is supported by a support substrate 61 via an adhesive layer 60 (FIG. 5A). The support substrate 61 is, for example, a glass substrate.

Next, as in the first manufacturing method, the silicon substrate 11 is thinned from the rear surface (FIG. 5B), and penetrative electrodes 15 and solder balls 16 are formed (FIG. 5C).

Thereafter, the adhesive layer 60 and support substrate 61 are removed from the silicon substrate 11 (FIG. 5D).

In the second manufacturing method, the silicon substrate 11 is supported by the support substrate 61, which enables the silicon substrate to be thinned from the rear surface easily.

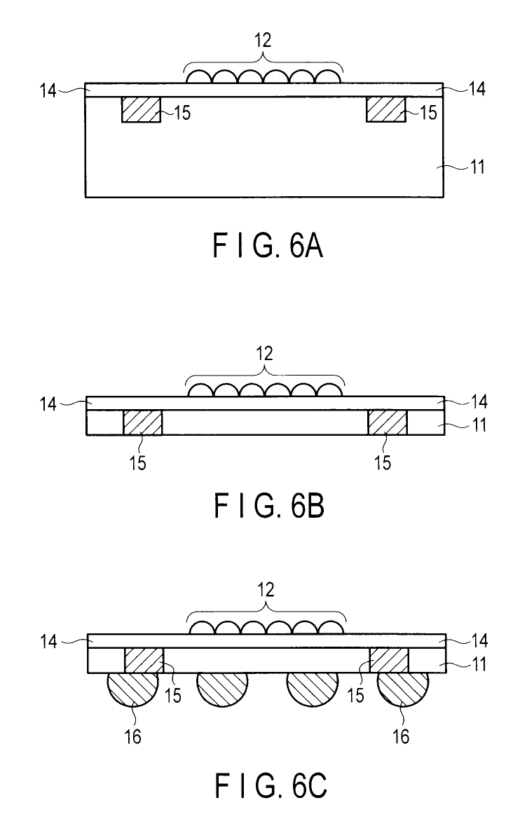

FIG. 6 shows still another method of manufacturing a first module section (a third manufacturing method).

In this manufacturing method, first, as shown in FIG. 6A, an imaging element (not shown) is formed on a silicon substrate 11 (D2 in thickness), then penetrative electrodes 15 is formed, and thereafter a circuit region 14 is formed, according to a known method. At this stage, the silicon substrate 11 is thicker than the predetermined thickness (D1) and therefore the penetrative electrodes 15 have not penetrated through the silicon substrate 11.

Next, as shown in FIG. 6B, the silicon substrate 11 is thinned from the rear surface so that the silicon substrate 11 have the predetermined thickness (D1). As a result, the penetrative electrodes 15 penetrate through the silicon substrate 11. At this time, as in the second manufacturing method, the silicon substrate 11 may be thinned from the rear surface with the silicon substrate 11 being supported by the support substrate.

Thereafter, as shown in FIG. 6C, solder balls 16 are formed.

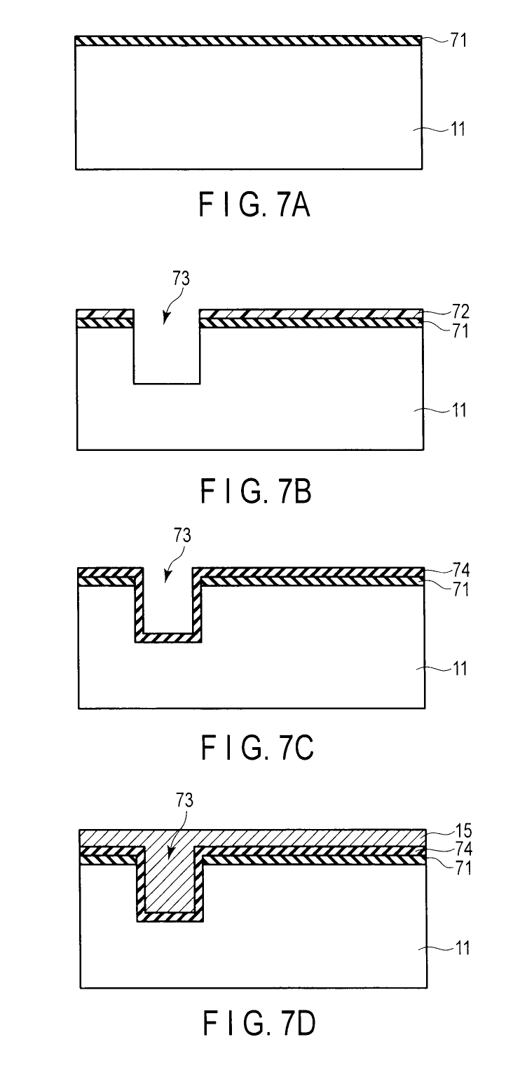

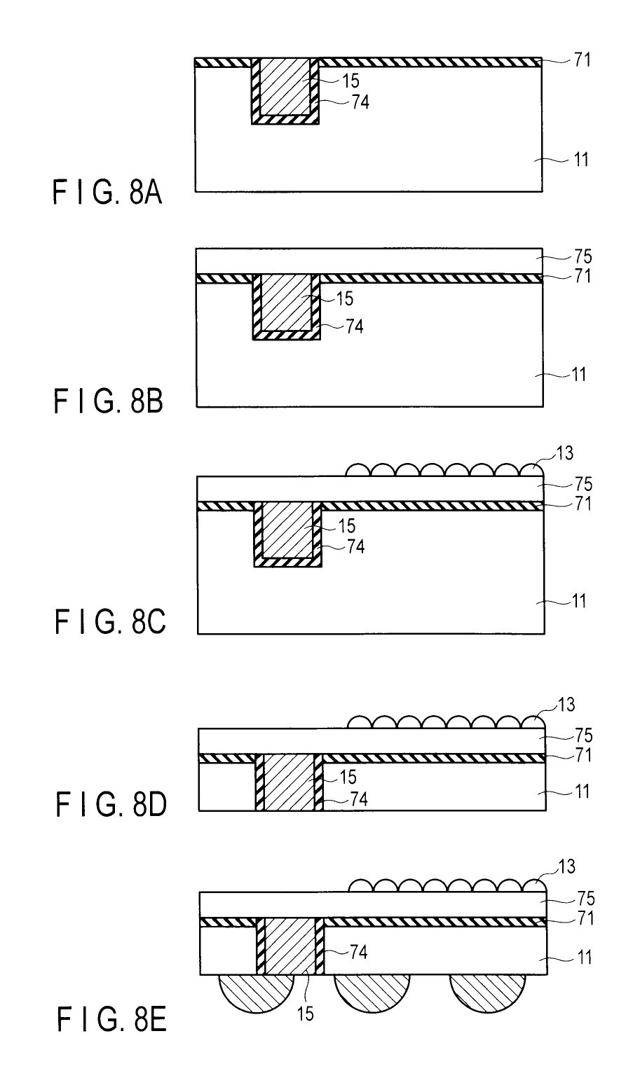

The third manufacturing method will be explained in detail with reference to FIGS. 7 and 8.

First, as shown in FIG. 7A, a first insulating film 71 is formed on the silicon substrate 11 (D2 in thickness). The first insulating film 71 is, for example, a silicon nitride film. Before forming the first insulating film 71, an imaging element, a transistor, and others (these not shown) are formed on the surface of the silicon substrate 11.

Next, as shown in FIG. 7B, a resist pattern 72 is formed on the first insulating film 71, using the resist pattern 72 as a mask, the first insulating film 71 and silicon substrate 11 are etched, thereby making a hole 73. The hole 73 penetrates through the first insulating film 71 but not through the silicon substrate 11. Thereafter, the resist pattern 72 is removed.

Next, as shown in FIG. 7C, a second insulating film 74 that covers the bottom surface and side surface of the hole 73 is formed on the entire surface. The second insulating film 74 is, for example, a silicon oxide film.

Next, as shown in FIG. 7D, a metal film 15 to be a penetrative electrode is formed on the entire surface to such a thickness as overflows the hole 73. The metal film 15 is, for example, a Cu film, a Ni film, a Ti film, or a metal silicide film of these. The metal film 15 is formed by, for example, CVD method, sputtering method, or plating method.

Next, as shown in FIG. 8A, using the first insulating film 71 as a stopper, the metal film 15 and second insulating film 74 outside the hole 73 are removed and the surface is planarized by CMP (Chemical Mechanical Polishing) method, etch back method, or the like.

Next, as shown in FIG. 8B, a wiring layer 75 is formed on the silicon substrate 11. The wiring layer 75 comprises a metal wiring layer, an interlayer insulating film, a plug, or the like (these not shown).

Next, as shown in FIG. 8C, a microlens 13 is formed via a color filter (not shown) on the wiring layer 75.

Next, as shown in FIG. 8D, the silicon substrate 11 is thinned from the rear surface by back grind or wet etching, thereby exposing the penetrative electrode 15.

Next, as shown in FIG. 8E, solder balls 16 are formed after rewiring (not shown) is performed on the rear surface of the silicon substrate 11.

### Second Embodiment

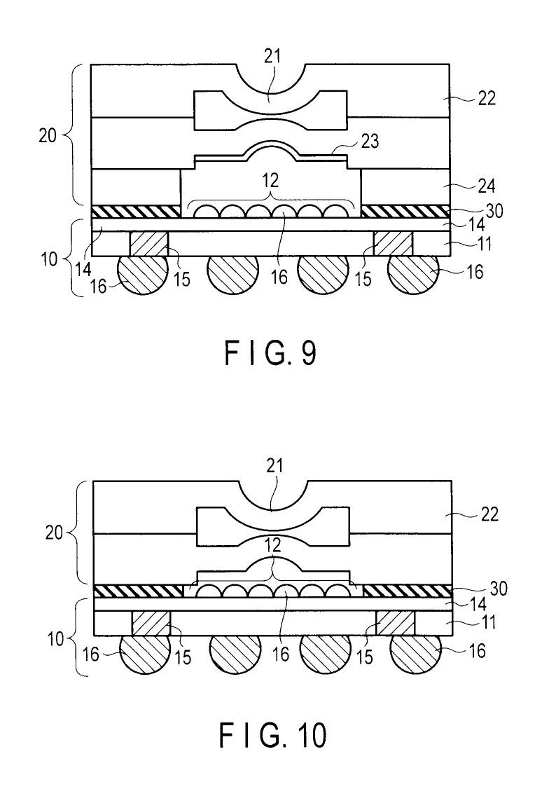

FIG. 9 is a sectional view showing a schematic configuration of a camera module according to a second embodiment.

In the following figures, the portions corresponding to the portions shown in the previously mentioned drawings are denoted by the same reference numerals and omitted its detail explanation.

The second embodiment is different from the first embodiment in that the IRCF 23 is directly formed on the imaging lens 21. This makes it possible to realize the low height more easily. If the IRCF 23 is not needed, the IRCF 23 is omitted.

### Third Embodiment

FIG. 10 is a sectional view showing a schematic configuration of a camera module according to a third embodiment.

The present embodiment differs from the first embodiment in that the spacer 24 is eliminated from the second module section 20 and that the lens holder 22 constituting the second module section 20 is directly bonded to the adhesive layer 30 so that the lens holder 22 seal the imaging region 12. This makes it possible to realize the low height more easily.

In the present embodiment, for example, the imaging lens 21 is so designed that the focal length accords the imaging surface of the imaging element even if there is no spacer 24.

In FIG. 10, the IRCF 23 is omitted for the sake of simplicity. If the IRCF 23 is not needed, the IRCF 23 is eliminated.

### Fourth Embodiment

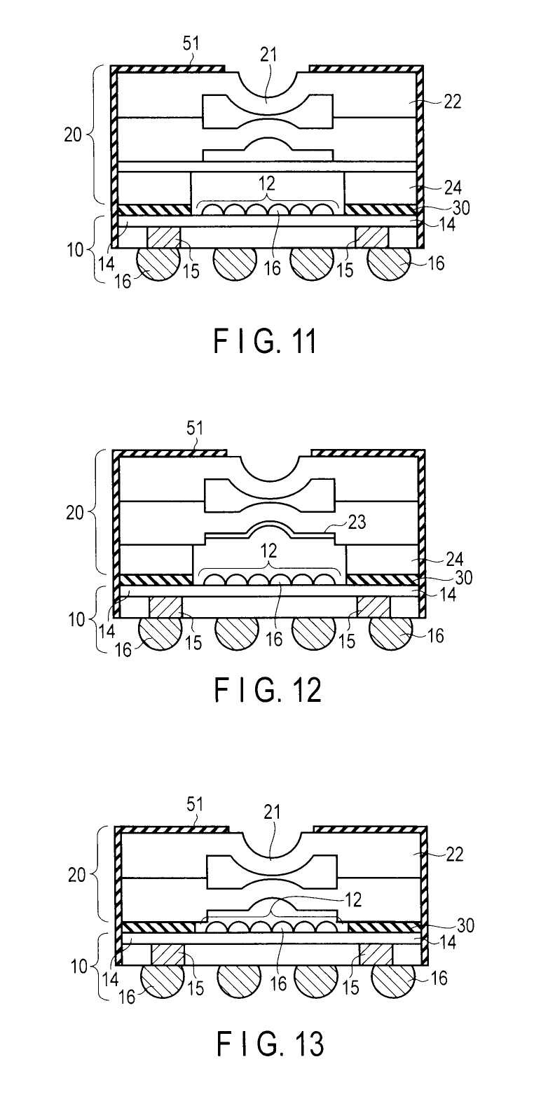

FIG. 11 is a sectional view showing a schematic configuration of a camera module according to a fourth embodiment.

The present embodiment differs from the first embodiment in that a light shielding member 51 is provided on the side surface and top surface (upper surface) of the second module section 20. However, the imaging lens 21 is not covered with the light shielding member 51 so as to enable light to enter the imaging lens 21. The side surface of the second module section 20 is not necessarily covered with the light shielding member 51.

FIGS. 12 and 13 show modifications of the present embodiment. FIG. 12 shows an example of providing the light shielding member 51 for the camera module of the second embodiment. FIG. 13 shows an example of providing the light shielding member 51 for the camera module of the third embodiment.

### Fifth Embodiment

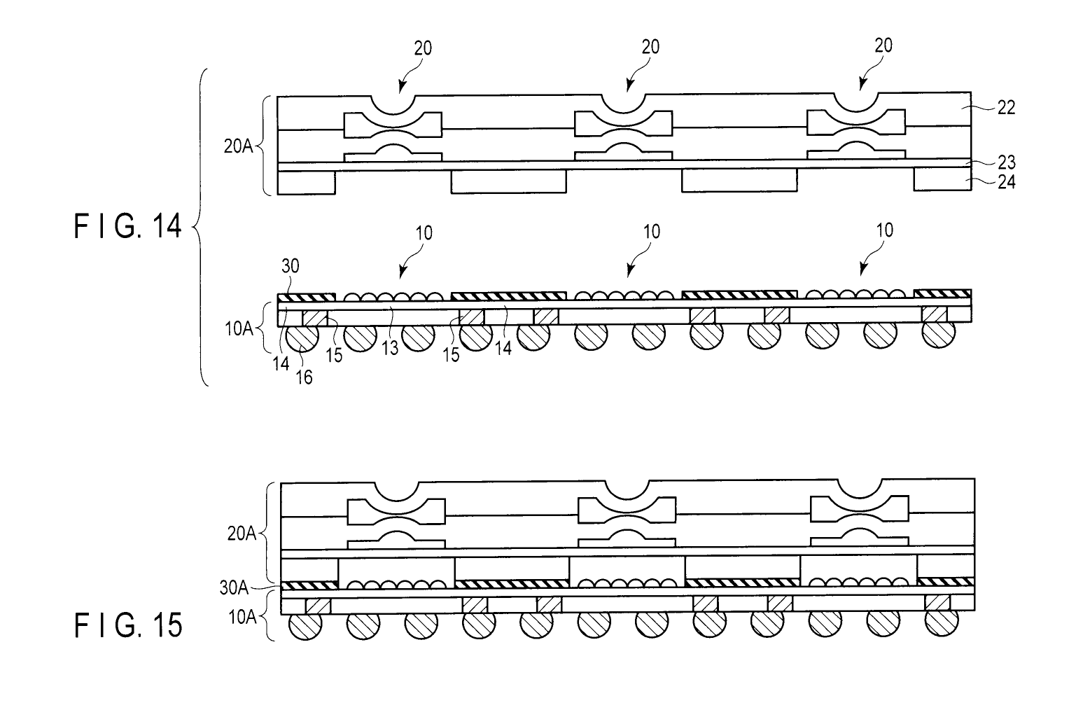

FIGS. 14 to 16 are sectional views to explain a method of manufacturing a camera module according to a fifth embodiment.

The manufacturing method of the present embodiment utilizes F-WLCM (full wafer level module).

First, as shown in FIG. 14, a first wafer 10A into which a plurality of first module sections 10 are integrated and a second wafer 20A into which a plurality of second module sections 20 are integrated are prepared. These first and second wafers are aligned with each other. An adhesive layer 30 is provided on a circuit region 14 of the first wafer 10A excluding an imaging region 12.

In FIG. 14, while the second module sections explained in the first embodiment are shown, second module sections of other embodiments (including modifications) may be used.

Next, as shown in FIG. 15, the second wafer 20A is directly bonded to the adhesive layer 30.

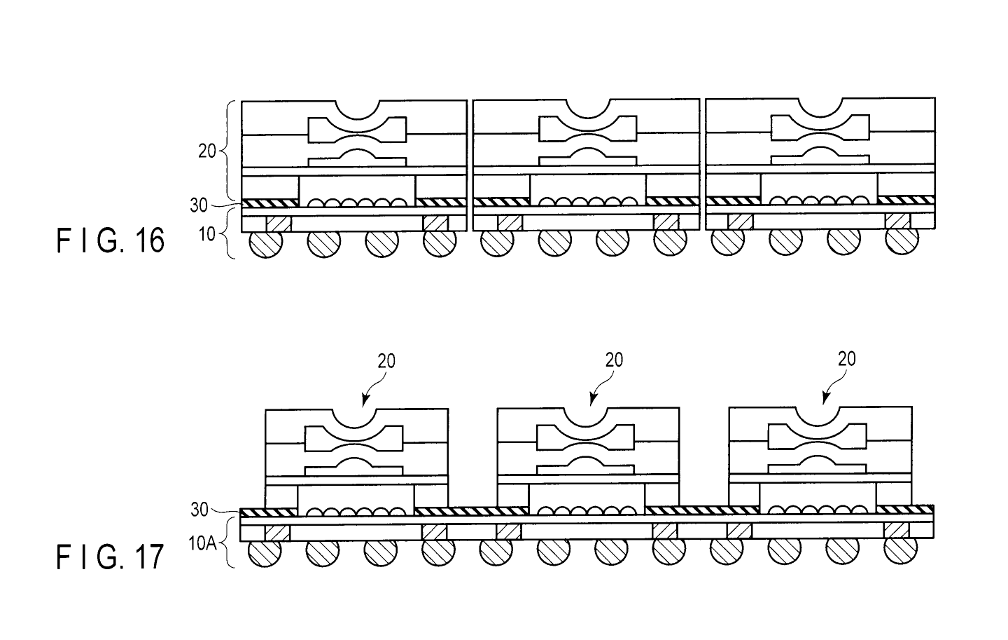

Then, as shown in FIG. 16, the first and second wafers 10A, 20A bonded together are diced (segmented) along dicing lines (not shown), thereby producing the plurality of camera modules.

### Sixth Embodiment

FIGS. 17 to 19 are sectional views to explain a method of manufacturing a camera module according to a sixth embodiment.

The manufacturing method of the present embodiment utilizes S-WLCM (semi full wafer level module).

The present embodiment differs from the fifth embodiment in that a camera module comprising a light shielding member is manufactured.

After the step of FIG. 15 in the fifth embodiment, the second wafer 20A is divided (segmented) into a plurality of second module sections 20 as shown in FIG. 17.

While in FIG. 17, second module sections explained in the first embodiment is shown, second module sections of other embodiments (including modifications) may be used.

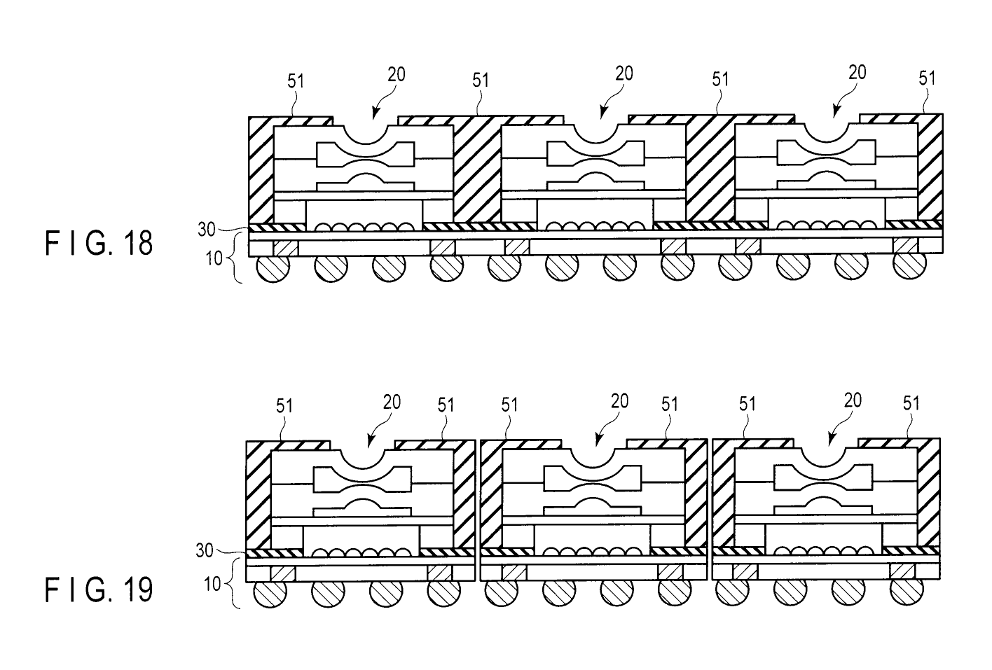

As shown in FIG. 18, a space between adjacent second module sections 20 is filled with a light shielding member 51. The light shielding member 51 is also provided on the top surface (upper surface) of the second module section 20. The light shielding member 51 on the top surface (upper surface) of the second module section 20 is provided so as to enable light to enter the imaging lens of the second module section 20.

Then, as shown in FIG. 19, the resulting wafers are diced (segmented), thereby producing the plurality of camera modules.

### Seventh Embodiment

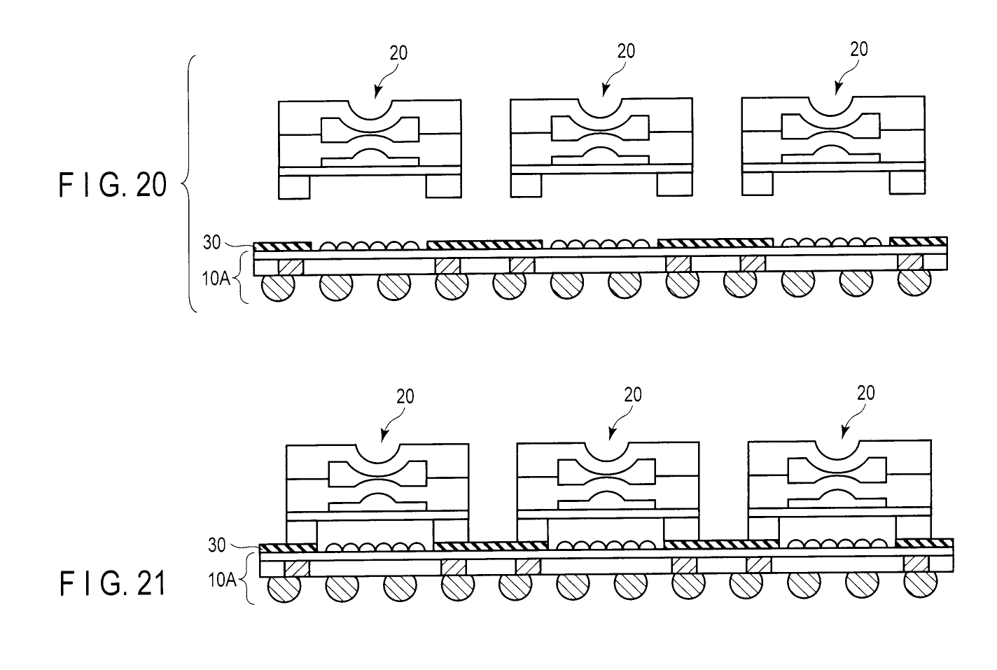

FIGS. 20 to 23 are sectional views to explain a method of manufacturing a camera module according to a seventh embodiment.

The manufacturing method of the present embodiment utilizes S-WLCM (semi full wafer level camera module).

First, as shown in FIG. 20, a plurality of second module sections 20 are aligned with a first wafer 10A.

In FIG. 20, while the second module sections explained in the first embodiment are shown, second module sections of other embodiments (including modifications) may be used.

Next, as shown in FIG. 21, the second module sections 20 are directly bonded to an adhesive layer 30 on the first wafer 10A.

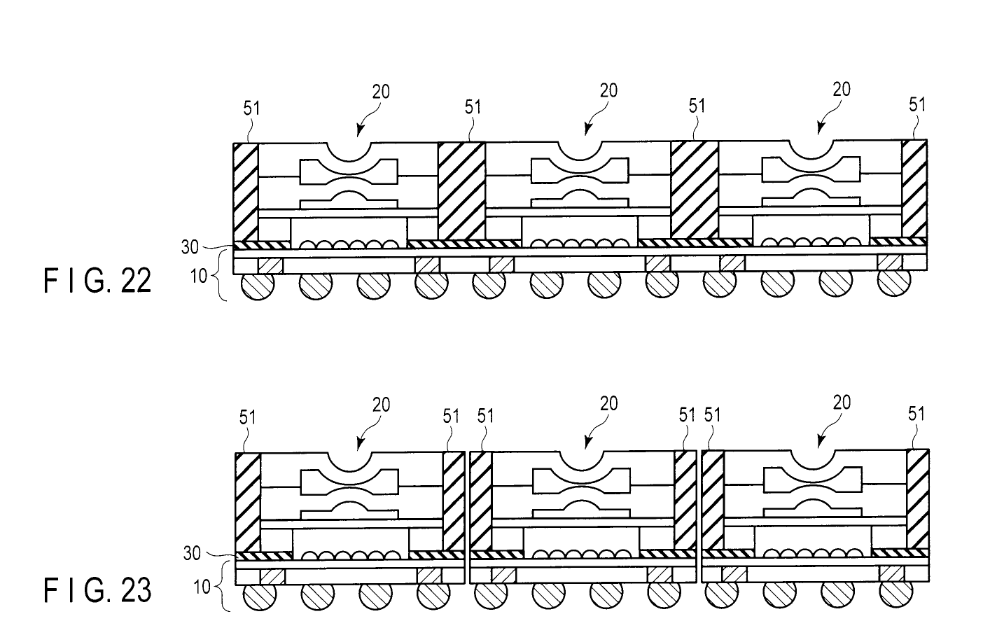

Next, as shown in FIG. 22, a space between adjacent second module sections 20 is filled with a light shielding member 51.

Then, as shown in FIG. 23, the resulting wafers are diced (segmented) along dicing lines (not shown), thereby producing the plurality of camera modules.

### Eighth Embodiment

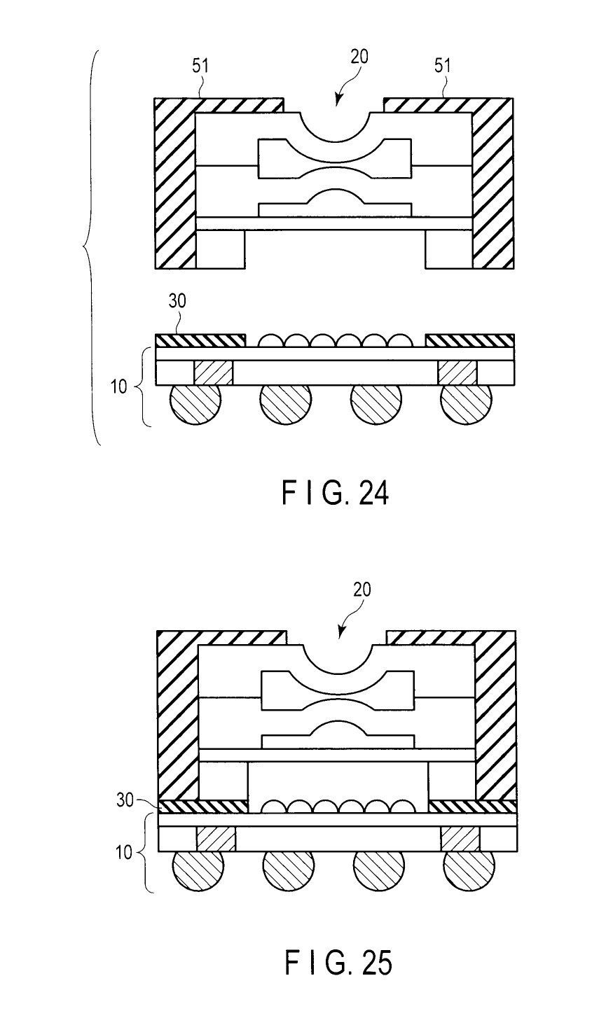

FIGS. 24 and 25 are sectional views to explain a method of manufacturing a camera module according to an eighth embodiment.

The manufacturing method of the eighth embodiment utilizes CSCM (chip scale camera module).

First, as shown in FIG. 24, a first module section 10 and a second module section 20 are aligned with each other.

While in FIG. 24, the second module section of the first embodiment provided with a light shielding member is shown, the light shielding member may not be used. In addition, a second module section of other embodiments (including a modification) may be used.

Thereafter, as shown in FIG. 25, the second module section 20 is directly bonded to the adhesive layer 30, thereby producing the camera module.

How much the low height is made by the aforementioned embodiments will be explained with concrete descriptions.

The height of a camera module of the comparative example (with a cover glass and a spacer) of FIG. 3 is, for example, 2 to 3 mm in the case of VGA.

The height of a camera module of the first embodiment (with no cover glass and a spacer) is, for example, 1.5 to 2 mm in the case of VGA.

The height of a camera module of the third embodiment (with no cover glass and no spacer) is, for example, 1.0 to 1.5 mm in the case of VGA.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera module comprising:
a semiconductor substrate having a first main surface and a second main surface facing the first main surface;
an imaging region provided on the first main surface;
a penetrative electrode penetrating through the semiconductor substrate between the first main surface and the second main surface;
an adhesive layer provided on the first main surface, the adhesive layer being located outside the imaging region; and
a lens member directly bonded to the adhesive layer, the lens member sealing the imaging region and the lens member housing an imaging lens therein.

2. The camera module according to claim 1, wherein the lens member includes a frame-shaped spacer which encloses the imaging region and the spacer is directly connected to the adhesive layer.

3. The camera module according to claim 1, wherein the lens member includes a lens holding member that holds the imaging lens, and the lens holding member is directly connected to the adhesive layer.

4. The camera module according to claim 1, wherein the lens member and the imaging region are configured to have a space therebetween.

5. The camera module according to claim 1, further comprising: a light shielding member configured to shield light and the light shielding member being provided on a part of the lens member so that the light enter the imaging lens.

6. A method of manufacturing a camera module, the camera module comprising a semiconductor substrate having a first main surface and a second main surface facing the first main surface, the semiconductor substrate having a thickness of D1; an imaging region provided on the first main surface; a penetrative electrode penetrating through the semiconductor substrate between the first main surface and the second main surface; an adhesive layer provided on the first main surface, the adhesive layer being located outside the imaging region; and a lens member directly bonded to the adhesive layer, the lens member sealing the imaging region and the lens member housing an imaging lens therein.
the method comprising:
forming the imaging region on a first main surface of a semiconductor substrate having a thickness of D2 (>D1);
thinning the semiconductor substrate to D1, the thinning being started from a second main surface side of the semiconductor substrate, the second main surface facing the first main surface;
forming the penetrative electrode in a through hole, the through hole penetrating through the semiconductor substrate between the first main surface and the second main surface;
providing the adhesive layer on the first main surface outside the imaging region; and
directly bonding the lens member to the adhesive layer.

7. The method according to claim 6, wherein the thinning the semiconductor substrate to Dl includes thinning the semiconductor substrate with the first main surface being fixed on a support member.

8. The method according to claim 7, further comprising: separating the support member from the semiconductor substrate after thinning the semiconductor substrate to D1.

9. A method of manufacturing a camera module, the camera module comprising a semiconductor substrate having a first main surface and a second main surface facing the first main surface, the semiconductor substrate having a thickness of D1; an imaging region provided on the first main surface; a penetrative electrode penetrating through the semiconductor substrate between the first main surface and the second main surface; an adhesive layer provided on the first main surface, the adhesive layer being located outside the imaging region; and a lens member directly bonded to the adhesive layer, the lens member sealing the imaging region and the lens member housing an imaging lens therein.
the method comprising:
forming the imaging region on a first main surface of a semiconductor substrate having a thickness of D2 (>D1);
forming a trench in the first main surface;
forming the penetrative electrode in the trench;
thinning the semiconductor substrate to D1, the thinning being starting from a second main surface side of the semiconductor substrate, the second main surface facing the first main surface;
providing the adhesive layer on the first main surface outside the imaging region; and
directly bonding the lens member to the adhesive layer.

10. The method according to claim 9, wherein the forming the penetrative electrode in the trench includes forming a conductive film to be the penetrative electrode on the first main surface so that the trench be filled, and forming the penetrative electrode by removing the conductive film outside the trench.

11. The method according to claim 10, wherein the forming the conductive film is performed by CVD method, sputtering method, or plating method.

12. The method according to claim 10, wherein the removing the conductive film outside the trench is performed by CMP method or etching method.
